(19) United States
(12) Patent Application Publication
(10) Pub. No.: US 2019/0324606 A1
(43) Pub. Date: Oct. 24, 2019

(54) ONLINE TRAINING OF SEGMENTATION MODEL VIA INTERACTIONS WITH INTERACTIVE COMPUTING ENVIRONMENT

(71) Applicant: Adobe Inc., San Jose, CA (US)

(72) Inventors: Branislav Kveton, San Jose, CA (US); Zheng Wen, Fremont, CA (US); Hung Bui, Sunnyvale, CA (US); Tong Yu, San Mateo, CA (US)

(21) Appl. No.: 15/957,706

(22) Filed: Apr. 19, 2018

(51) Int. Cl. G06F 3/0483; G06N 99/00; H04L 29/08; G06F 17/21

(52) U.S. Cl. CPC G06F 3/0483; G06F 17/212; H04L 67/22; G06N 99/005

(57) ABSTRACT

Systems and methods for customizing an interactive experience based on topics determined from an online topic model. In an example, a segmentation application executing on a computing device accesses past user interaction vectors that represent interaction data from an electronic content delivery system. The segmentation application accesses a segmentation model having parameters. The segmentation application updates the parameters by performing tensor decomposition on a tensor built from the past user interaction vectors and calculating updating values of the parameters from the tensor decomposition. The segmentation application performs a segmentation of user devices by applying the segmentation model with the updated parameters to the present user interaction vector. The segmentation assigns the user device to the user segment. The segmentation application transmits data describing the segmentation to the electronic content delivery system.

### TECHNICAL FIELD

This disclosure generally relates to machine learning models that are used with interactive computing environments (e.g., websites). More specifically, but not by way of limitation, this disclosure relates to using interactions with an interactive computing environment to perform online training of segmentation models that, in some cases, impact how the interactive computing environment is presented to certain segments of user devices.

### BACKGROUND

Online content providers perform user segmentation for many reasons, such as for customization of online content, improved targeting of electronic services, and reduction of expended computing resources. For example, an online content provider may modify how an interactive computing environment, such as a website, is presented to a given user device based on a segment to which the user device is assigned (either directly or through a user associated with the device). Examples of modifications include tailoring content for a device assigned to a particular segment, more prominently displaying user interface elements for devices in a particular segment, or transmitting website suggestions devices in a particular segment.

More specifically, computing systems that host interactive computing environments, such as web servers, log user visits and other interactions with interactive computing environments. User interactions can include operations performed on an interactive computing environment by a user device, such as clicking, dragging, navigation, entered search terms, and the like. These user interactions include a user identifier and other data such as the actions that the user took with the interactive computing environment.

Computing systems can perform segmentation based on latent variables. Latent variables are unobservable factors derivable from observable interactions within a dataset of user interactions. For example, the computing system can identify that a user is interested in cars from the user interaction data that does not observably indicate that a user is interested in cars. The computing system can then segment the user, or cluster, the user with similar users.

However, existing segmentation solutions present disadvantages. For example, some existing solutions require that a large, static data set of user interactions be present prior to analysis. But waiting until a complete set of data has arrived reduces the ability of the computing system to adapt to changes in the interaction data. Therefore, a computing system may not segment users correctly. For example, a computing system may receive interaction data that includes electronic keyword searches for textbooks from university students during the day and then receive user interactions that identify middle-aged adults browsing for novels during the week. An analysis of such data results in multiple latent variable predictions, but the variable changes over time (e.g., the prediction for “novels” is likely incorrect during the day). Similarly, solutions that extend traditional methods for offline, i.e., not real-time, learning of latent variables into an online, i.e. real time, setting such as expectation maximization techniques are computationally efficient but also reach sub-optimum results.

### SUMMARY

Systems and methods are disclosed herein for using interactions with an interactive computing environment to perform online training of segmentation models that, in some cases, impact how the interactive computing environment is presented to certain segments of user devices. In an example, a segmentation application executing on a computing device accesses past user interaction vectors that represent interaction data from an electronic content delivery system. The interaction data is generated by prior interactions between one or more user devices and an interactive computing environment provided by the electronic content delivery system. The segmentation application receives, from a user device, a present user interaction vector representing an activity by a particular user device. The segmentation application causes the electronic content delivery system to modify the interactive computing environment based on a user segment computed from the interaction data. The segmentation application updates the parameters of the segmentation model by (i) performing tensor decomposition on a tensor built from the past user interaction vectors and (ii) calculating updated values of the parameters from the tensor decomposition. The segmentation application performs a segmentation of user devices by applying the segmentation model with the updated parameters to the present user interaction vector. The segmentation assigns the user device to the user segment. The segmentation application transmits data describing the segmentation to the electronic content delivery system, where the data describing the segmentation is usable for customizing the interactive computing environment.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE FIGURES

Features, embodiments, and advantages of the present disclosure are better understood when the following Detailed Description is read with reference to the accompanying drawings.

FIG. 1 depicts an example of a computing environment for performing user segmentation, according to certain embodiments of the present disclosure.

FIG. 2 is a flowchart showing an exemplary method of modifying electronic content in an interactive computing environment, according to certain embodiments of the present disclosure.

FIG. 3 is a flowchart showing an exemplary method of creating a user segment by using online training of a segmentation model, according to certain embodiments of the present disclosure.

FIG. 4 depicts exemplary results from using online training of a segmentation model, according to certain embodiments of the present disclosure.

FIG. 5 depicts an example of a computing system used to perform user segmentation or topic modeling, according to certain embodiments of the present disclosure.

### DETAILED DESCRIPTION

Certain embodiments involve using interactions with an interactive computing environment to perform online training of segmentation models and, in some cases, modify how the interactive computing environment is presented to certain segments of user devices. More specifically, embodiments described herein use segmentation models configured to use online learning to predict user segments based on latent variables determined from user interaction data. For instance, a segmentation application generates and updates parameters for a segmentation model from a decomposition of a tensor based on the user interaction data. A tensor, an object that is analogous to a vector, is used to represent the user interaction data in such a manner that a decomposed tensor permits the detection of latent variables in the user interaction data. Computing model parameter values from a decomposed tensor thereby facilitates learning the determined latent variables. The segmentation model, as configured with these parameters, segments user devices according to one or more latent variables derived with the segmentation model. The interactive computing environment can be customized to particular devices assigned to particular segments.

The following non-limiting example is provided to introduce certain embodiments. A segmentation application executing on a computing system accesses past user interaction vectors that represent interaction data from an online content delivery system such as a web server. The interaction data is generated by prior interactions between one or more user devices and an interactive computing environment, such as an image-hosting website, with the past interaction vectors representing activities such as image searches, downloads, image-editing operations, etc. The segmentation application receives a present user interaction vector representing an activity by a user device, such as an image search via the image-hosting website.

Continuing the example, the segmentation application accesses a segmentation model that is used to segment user devices. The segmentation application computes parameter values for this model's parameters by, for example, generating a tensor from the past user interaction vectors. The past user interaction vectors indicate (i) a search for a term “lens,” and (ii) an entered website address of “www.baseball.com.” Decomposing the tensor enables the discovery of latent variables. Additionally, the parameter values are calculated in such a manner as to minimize a cumulative error as the number of iterations increases. The segmentation application provides the parameters to the segmentation model, which is trained with two user interactions previously received.

In turn, the segmentation model determines a latent variable from the user data and segments the user according to users who identify with “photography.” Based on the determined variable, the computing system causes the interactive computing environment to be modified. For example, a computing system that includes (or communicates with) the segmentation application can receive data indicating the segment to which a particular user device is assigned. The computing system can reconfigure the interactive computing environment based on the segment by, for example, causing the layout of interface elements to be modified such that content that is relevant to photography is more prominently displayed and links, images, and other interface elements that are related to photography are provided. The segmentation application improves computational efficiency by maintaining the number of past user interaction vectors below a threshold level. For example, the segmentation application can use reservoir sampling to remove a random past user interaction data when a new, e.g., real time, interaction vector is generated from an online interaction.

Certain embodiments described herein predict, in real time, latent variables from live user interaction data while maintaining computational complexity within determinable bounds. For instance, as discussed above, traditional models are limited to supervised or unsupervised learning methodologies because such models require a complete dataset rather than operate in an online, i.e., real-time fashion. And previous models have a computational complexity that is proportional to the a number of user interaction vectors that have been received and processed, which increases the time required to make a prediction of a segment as the number of interaction vectors grow. In contrast, embodiments described herein use reservoir sampling to maintain a number of past user interaction vectors below a threshold, thereby limiting the complexity and improving the performance of computing systems that execute segmentation models.

### Certain Definitions

As used herein, the terms “user” and “visitor” refer to an entity that interacts with a computing service such as a website or email provider.

As used herein, the term “interaction data” refers to electronic data that is automatically generated by a set of electronic communications in which a user device performs one or more operations with an interactive computing environment, such as a website, via a data network. In some embodiments, interaction data describes or otherwise indicates one or more attributes of interactions by user devices with different sets of online content. For example, the interaction data could include records with one or more fields that describe an interaction. Examples of these fields include a timestamp of an interaction, a description of an interaction (e.g., a click, a selection of a navigation command for video or slideshow, a selection of text content, etc.), a location of the interaction within a webpage, an identifier of a particular content item (e.g., an address of webpage, an identifier of a video content or text content within the same webpage, etc.), or any other suitable data that describes or otherwise indicates how a user device has interacted with a given content item. Interaction data can also include whether a particular advertisement has been displayed on a particular user device. Interaction data can also be interactions with a mobile application.

As used herein, the terms “online” and “online learning” refer to a process of training a model such as a predictive model while data is arriving in real-time. For example, a segmentation model can receive live user interaction data from an interactive computing environment, determine a latent variable in the live data.

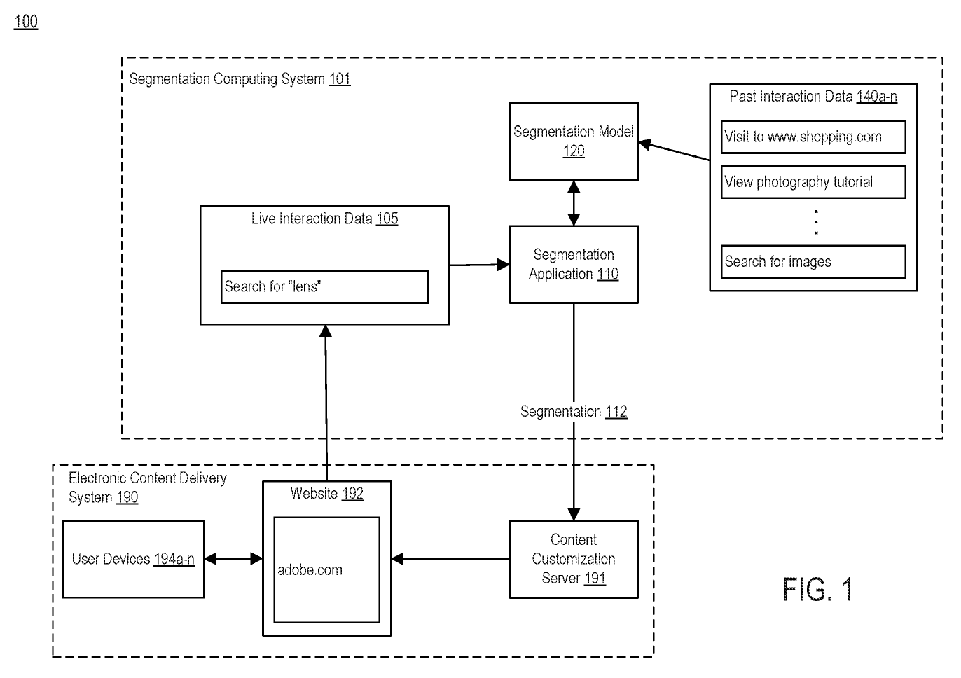

FIG. 1 depicts an segmentation computing environment 100 in which a segmentation computing system 101 performs user segmentation and, in some cases, facilitates modifications to an interactive user experience via an online platform provided by electronic content delivery system 190. In various embodiments, segmentation computing system 101 operates in conjunction with electronic content delivery system 190 to segment users of an online platform based on latent variables.

Electronic content delivery system 190 includes one or more user devices 194a-n, content customization server 191, and website 192. Segmentation computing system 101 provides a segmentation the electronic content delivery system. In some embodiments, providing a segmentation to electronic content delivery system 190 causes one or more features of the online environment to be changed such that subsequent interactive user experiences are enhanced for various user devices 194a-n.

Examples of user devices 194a-n are computing devices such as desktop computers, laptop computers, tablets, smart phones, etc. A user operating one of user devices 194a-n can interact with a remote service in some manner. For example, user device 194a can operate a web browser such as Internet Explorer®, Safari®, Chrome®, etc. to access a website such as website 192. User devices 194a-n can be chat clients, messaging clients, email clients, or mobile software applications. Further, in an embodiment, if a user device 194a-n is offline, e.g., in airplane mode when user interactions occur, the interactions can be held on the device and sent in the next time the applications runs when the device is online, which may be days or months later.

Each user device 194a-n can interact with website 192 and thereby cause a user interaction to be logged as a user interaction or user interaction vector. A user interaction can include an identifier and a time stamp. The identifier uniquely identifies the visitor, i.e., the user of a device of user devices 194a-n. The identifier can be an identifying piece of data such as a web cookie, device identifier, user identifier, etc.

Electronic content delivery system 190 captures interactions with website 192 from user devices 194a-n and provides the interactions to an external system. For example, electronic content delivery system 190 detects the user interactions and provides the user interactions as live interaction data 105 to segmentation computing system 101. In turn, segmentation computing system 101 determines a segmentation from the live interaction data 105 and past user interaction data, and provides a segmentation 112 to the electronic content delivery system 190, which can make further adjustments as necessary to the content.

Segmentation computing system 101 includes one or more of segmentation model 120, segmentation application 110, live interaction data 105, past interaction data 140a-n and a segmentation 112. Live interaction data 105 and past interaction data 140a-n represent a user's interaction with an interactive computing environment such as a website. Examples include a visit, a search, where a user clicked on a webpage, a login to a website, a purchase, and the like. Live interaction data 105 includes data that is received in real-time by segmentation computing system 101. As shown, live interaction data 105 includes a “search for ‘lens.’”

Segmentation application 110 determines a set of parameters from past interaction data 140a-n. The parameters include (i) a conditional probability that a particular user interaction data has a particular topic at a given time, and (ii) a probability that a particular topic will occur at a given time. Segmentation application 110 computes segmentation model 120 from past user interaction data. Electronic content delivery system 190 includes one or more user devices 194, website 192, and content customization server 191. Segmentation application 110 inserts the determined parameters into a feature vector and provides the feature vector to the applicable model.

Electronic content delivery system 190 and segmentation computing system 101 can operate in conjunction with each other to detect user interactions from a particular user from an interactive computing environment, provide live, or present, interaction data and past interaction data to a predictive model such as segmentation model 120, predict a segmentation of a the user based on a latent variable, and adjust the content of the interactive computing environment accordingly.

Segmentation application 110 executes on a suitable computing system such as segmentation computing system 101. In an embodiment, segmentation application 110 can execute on a remote device such as a server. Segmentation application 110 receives live interaction data 105, provides live interaction data 105 and past interaction data 140a-n to segmentation model 120. Segmentation application 110 receives a prediction of a segmentation 112, and provides the segmentation 112 to an external system such as electronic content delivery system 190.

Past interaction data 140a-n includes interaction data that has already been used to train the segmentation model 120. As shown, past user interaction data 140a-n includes three entries: “visit to shopping.com,” “view photography tutorial,” and “search for images.” Live interaction data 105 can be related to past interaction data 140a-n, for example, past user interaction data may indicate a user's visit to a website and a live user interaction data may indicate a follow-on event such as a purchase.

The segmentation model 120 predicts latent variables from user interaction data. For example, segmentation model 120 determines a latent variable from a given set of latent variables, where a latent variable exists for every time t. Using online learning, applying the segmentation model 120 can determine, in real time, a segmentation 112 that is represented by the live interaction data 105, and update the segmentation model based on the prediction. Latent variables are unobservable factors derivable from observable interactions within a dataset of user interactions, such as “photography,” “shopping,” “researcher,” “academic,” “attorney,” “purchaser,” “shopper,” “child,” etc.

In an example, segmentation application 110 receives live interaction data 105 as a result of one of the user devices 194a-n interacting with an interactive computing environment. Segmentation application 110 determines a set of parameters for segmentation model 120 by determining a tensor from the live user interaction data 105. Segmentation application 110 decomposes the tensor. Segmentation application 110 provides the parameters to the segmentation model 120.

Segmentation model 120, configured with the parameters, predicts a latent variable in live interaction data 105 based on the past user interaction data 140a-n. Continuing the above example, segmentation model 120 determines that the user device as indicated by the live interaction data 105 can be segmented into a “photography” segment.

Segmentation application 110 provides segmentation 112 to the content customization server 191, which in turn can update or modify the electronic content on website 192 or another interactive computing environment to better suit a user device 194a-n. Content customization server 191 can modify the online experience such as the website 192 in different manners to suit user device 194a-n.

For instance, content customization server 191 could present user device 194a with certain interface elements that search databases for different content items, or with interface elements that cause a web server to perform one or more operations on the combination of content items (e.g., creating a layered image, initiating a transaction to obtain a set of products, etc.). Similarly, content customization server 191 can modify an interactive experience such as by altering the placement of menu functions, hiding or displaying content, for a user devices in a first segment, and present a different experience to user devices in another segment to improve the user experience for those users.

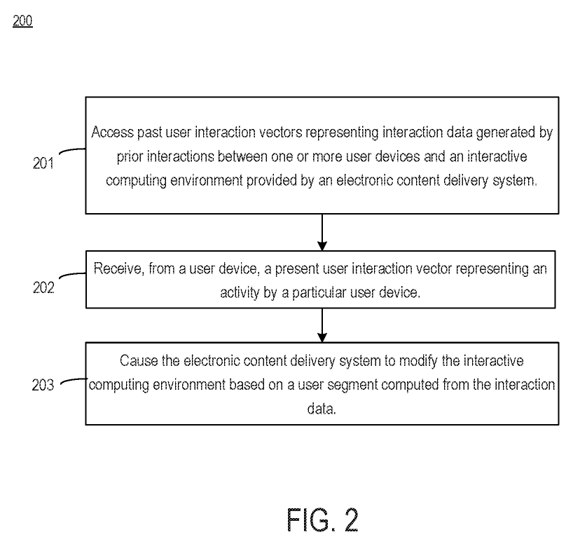

FIG. 2 is a flowchart showing an example method of modifying electronic content in an interactive computing environment, according to certain embodiments of the present disclosure. For illustrative purposes, process 200 is described with reference to certain examples depicted in the figures. Other implementations, however, are possible.

At block 201, process 200 involves accessing past user interaction vectors representing interaction data generated by prior interactions between one or more user devices and an interactive computing environment provided by an electronic content delivery system. For example, segmentation application 110 accesses past user interaction data 140a-n. Past user interaction data 140a-n is generated from previous interactions of user devices 194a-n with an interactive computing environment such as website 192. Past user interaction data 140a-n can be stored in memory, secondary storage, or on some other storage device. Segmentation application 110 reads the storage device and obtain the past user interaction data 140a-n.

At block 202, process 200 involves receiving, from a user device, a present user interaction vector representing an activity by a particular user device. Segmentation application 110 receives live interaction data 105 from an interactive computing environment such as website 192. Segmentation application 110 can receive the live interaction data 105 directly from an external device such as electronic content delivery system 190. Segmentation application 110 can also read the live interaction data 105 from a memory, secondary storage, or other storage device.

At block 203, process 200 involves causing the electronic content delivery system to modify the interactive computing environment based on a user segment computed from the interaction data. As discussed further with respect to process 300, which can implement block 203 of process 200, segmentation application 110 provides one or more of the live interaction data 105 and the past user interaction data 140a-n to segmentation model 120.

In an illustrative example, the process by which segmentation model 120 predicts online latent variables or latent topics can also be referred to as online topic modeling. Subsequently, the model application updates its internal parameters with the prediction and receives a second headline. The model then predicts, based on the previous headline and prediction and the second headline, a topic for the second headline.

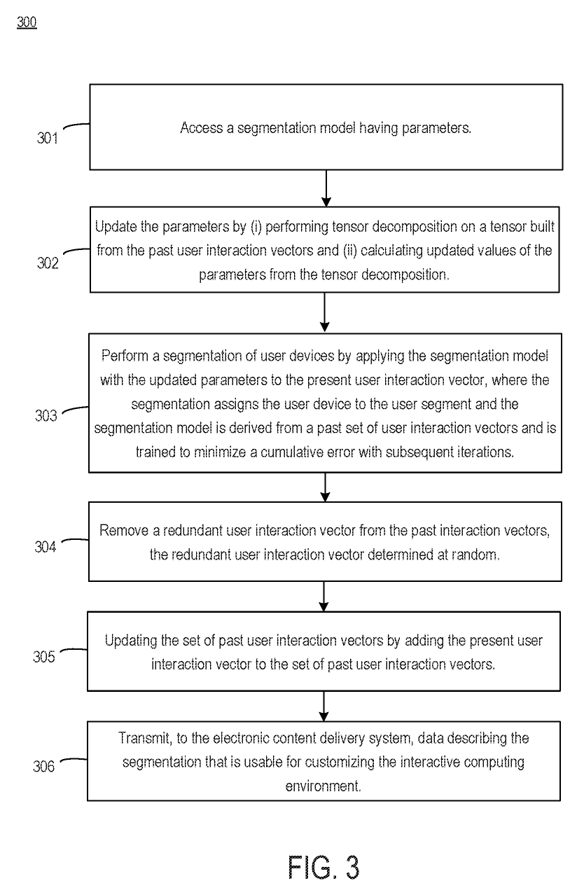

FIG. 3 depicts an example of a process 300 for creating a user segment by using online training of a segmentation model, according to certain embodiments of the present disclosure. For illustrative purposes, process 300 is described with reference to certain examples depicted in the figures. Other implementations, however, are possible.

At block 301, process 300 involves accessing a segmentation model having parameters. Segmentation application 110 accesses segmentation model 120, which can be an online topic prediction model. Using an online topic model, segmentation application 110 determines a set of parameters for segmentation model 120 such that segmentation model 120 can determine a latent topic for a user interaction data occurring at time t, based on previous user interaction data 140a-n. Segmentation model 120 uses a predetermined sequence of latent topics. The sequence does not have to be stochastic.

In order to obtain a prediction of a topic from segmentation model 120, segmentation application 110 determines a set of parameters. The set of parameters have low cumulative regret. Low cumulative regret refers to a quick convergence to a small value of error with respect to a theoretical solution. Over time, segmentation model 120 improves and becomes more accurate, i.e., closer to a theoretical solution. Segmentation application 110 and segmentation model 120 do not determine the theoretical solution, but theoretical solution can theoretically be determined in hindsight by knowing the latent topics (Ċₜ)ₜ₌₁ⁿ and the sampling distribution of the user interaction data.

Segmentation application 110 determines, for a set of parameters for an online topic model such that the online topic model predicts one topic of a sequence of n latent topics represented by (Ċₜ)ₜ₌₁ⁿ, where one topic exists for each time t. The segmentation model 120 analyzes user interaction data at t−1 data points and makes a prediction for time t. A single user interaction can be denoted by xₜ, where:

xₜ=(xₜ^{(\dot{l})})ₗ₌₁³ is a tuple of one-hot encoded user interactions or events at time t. At time t, each word xₜ^{(l)} is an independently and identically distributed random variable that is conditioned on Cₜ.

Once a determined set of parameters are applied to a sequence of user interaction data, segmentation model 120 can determine topics for each user interaction data, thereby enabling the segmentation computing system 101 to cluster users in real-time.

At block 302, process 300 involves updating the parameters by (i) performing tensor decomposition on a tensor built from the past user interaction vectors and (ii) calculating updated values of the parameters from the tensor decomposition.

Segmentation application 110 calculates an updated set of parameters by building a tensor from the past user interaction data and performing tensor decomposition. The segmentation application 110 receives, at time t, a set of one-hot encoded words indicated by: ((x_{z}^{(l)})ₗ₌₁³)_{z=1}^{t-1} from the first t−1 time steps. More specifically, the triplet of words at time t, i.e., (x_{z}^{(l)})ₗ₌₁³ correspond to live interaction data 105. For each user, three user interactions are shown as input to segmentation application 110, but other numbers of user interactions per user are possible.

Segmentation application 110 performs a series of steps in order to construct the tensor from the user interaction data. Segmentation application 110 constructs the second-order moment from the input words by computing an outer product of the user interaction data, where the second order moment is calculated by:

$${M}_{2 , t - 1} = \frac{1}{( t - 1 ) \vert {Π}_{2} ( 3 ) \vert} {\sum }_{z = 1}^{t - 1} {\sum }_{π ∈ {Π}_{2} ( 3 )} {x}_{z}^{( π ( 1 ) )} ⊗ {x}_{z}^{( π ( 2 ) )} ,$$

where

Π₂ (3) is the set of all 2-permutations of [3]={1, 2, 3}.

Segmentation application 110 performs Eigen decomposition to estimate Aₜ₋₁ and Uₜ₋₁. Segmentation application constructs a whitening matrix Wₜ₋₁.

Wₜ₋₁=Uₜ₋₁Aₜ₋₁^{-1/2}, where:

Aₜ₋₁∈ [symbol] ^{K×K} is the diagonal matrix of K positive eigenvalues of M_{2,t-1}, and

Uₜ₋₁∈ [symbol] ^{K×K} is the matrix of eigenvalues associated with the positive Eigenvalues.

Segmentation application 110 calculates a whitening matrix from the eigenvalue decomposition, where:

∀_{z}∈┌t−1┌,l∈┌3┐:y_{z}^{(l)}=Wₜ₋₁^{T}x_{z}^{(l)}

After whitening, segmentation application 110 builds the third-order tensor Tₜ₋₁ from whitened words ((y_{z}^{(l)})ₗ₌₁³)_{z=1}^{t-1}, where Π₃(3) is the set of all 3-permutations of [3]={1, 2, 3}.

The third order tensor Tₜ₋₁ is denoted by:

$${T}_{t - 1} = \frac{1}{( t - 1 ) \vert {Π}_{3} ( 3 ) \vert} {\sum }_{z = 1}^{t - 1} {\sum }_{π ∈ {Π}_{3} ( 3 )} ⊗ {y}_{z}^{( π ( 1 ) )} ⊗ {y}_{z}^{( π ( 2 ) )} ⊗ {y}_{z}^{( π ( 3 ) )}$$

Segmentation application 110 decomposes the tensor Tₜ₋₁ with the power iteration method and obtains:

\hat{θ}ₜ₋₁=(λ_{t-1,i})ᵢ₌₁^{K}(v_{t-1,i})ᵢ₌₁^{K}. λ(T_{t-1,i}) is the i-th eigenvalue of the decomposed tensor at time t and v(T_{t-1,i}) is the i-th eigenvector of the decomposed tensor at time t.

Segmentation application 110 calculates updated values of the parameters of segmentation model 120 from the tensor decomposition. More specifically, segmentation application 110 recovers the parameters of the model, u_{t-1,i} and ω_{t-1,i}. The parameter u_{t-1,i} represents the conditional probability of a particular user interaction data has topic at i at time t−1. The parameter ω_{t-1,i} represents the probability that topic i will occur at time t−1.

$${w}_{t - 1 , i} = \frac{1}{{λ}_{i}^{2}} , {u}_{t - 1 , i} = {{λ}_{t - 1 , i} ( {W}_{t - 1}^{⊤} )}^{+} {v}_{t - 1 , i} .$$

Segmentation application 110 provides the parameters w_{t-1,i} and u_{t-1,i} to the segmentation model 120.

At block 303, process 300 involves performing a segmentation of user devices by applying the segmentation model with the updated parameters to the present user interaction vector, where the segmentation assigns the user device to the user segment.

Segmentation application 110 provides the new model parameters u_{t-1,i} and ω_{t-1,i} to segmentation model 120 and segmentation model 120 updates accordingly. Using the updated parameters, segmentation model 120 predicts a topic from the user interaction data and model parameters. Segmentation application 110 can segment users according to the determined topic. The user device 194a-n that corresponds to the user is assigned to the user segment.

At block 304, process 300 involves removing a redundant user interaction vector from the past interaction vectors, the redundant user interaction vector determined at random.

As discussed, previous methods are not computationally efficient due to a time complexity at time t is linear in t. For example, previous solutions depend on a construction of a whitening matrix using eigenvector decomposition that relies on t−1 past observations to construct M_{2,t-1} and Tₜ₋₁. Further, the whitening operation depends on t because a plurality of past observations are whitened by a matrix Wₜ₋₁ that changes with t.

Accordingly, embodiments described herein provide further computational improvements by using reservoir sampling. Reservoir sampling maintains a random set of [symbol] past user interactions 140a-n, where: x_{z}, z∈[t−1].

When t≤R, an incoming live interaction data 105 is added to the pool. Additionally, when t>R, a live interaction data 105 replaces a random observation in the pool with probability R/(t−1). In this manner, the set of past user interactions does not grow to an unmanageable size over time. With reservoir sampling, segmentation application 110 operates with complexity that is independent of t.

At block 305, process 300 involves updating the set of past user interaction vectors by adding the present user interaction vector to the set of past user interaction vectors. Segmentation application 110 adds the live user interaction data 105 to the set of past user interaction vectors 140a-n. In this manner, the segmentation model 120 continues to learn in an online manner, e.g., iteration after iteration. Subsequent predictions obtained from segmentation model 120 are based on prior user interactions received such as live user interaction data 105.

At block 306, process 300 involves transmitting to the electronic content delivery system, data describing the segmentation that is usable for customizing the interactive computing environment.

Segmentation application 110 provides the determined segmentation 112 to the electronic content delivery system 190. Electronic content delivery system causes one or more features of the online environment such as website 192 to be changed such that subsequent interactive user experiences are enhanced for various user devices 194a-n.

Experimental Results

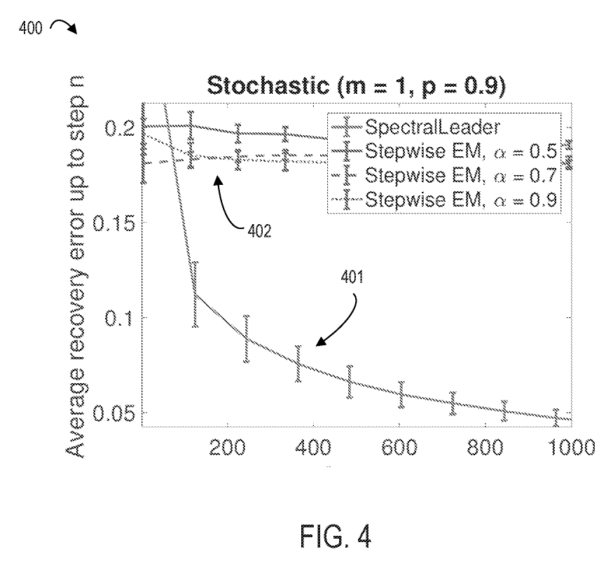

Embodiments described herein provide improvements over traditional models for user segmentation. FIG. 4 depicts examples of results from using online training of a segmentation model, according to certain embodiments of the present disclosure. More specifically, FIG. 4 depicts comparisons between segmentation computing system 101 and stepwise expectation maximization approaches.

Graph 400 depicts results of an exemplary configuration of an online topic model using the embodiments described herein (denoted by “SpectralLeader”) and indicated by 401, as compared to traditional stepwise expectation maximization algorithms (denoted by “Stepwise EM”), and indicated by 402. Graph 400 includes a vertical axis that indicates average recovery error and a horizontal axis that indicates time, i.e., interaction data vectors received.

More specifically, at each time t, model θₜ₋₁ learned from the first t−1 observations, by the stepwise expectation maximization or online topic learning. Reconstruction error is used to evaluate the segmentation model.

The expectation maximization results use varying values of α in a stochastic setting, where α is the learning rate of the stepwise expectation maximization As can be seen, with online topic modeling, the recovery error decreases over time more rapidly over time than the expectation maximization methods.

Example of a Computing System for Implementing Certain Embodiments

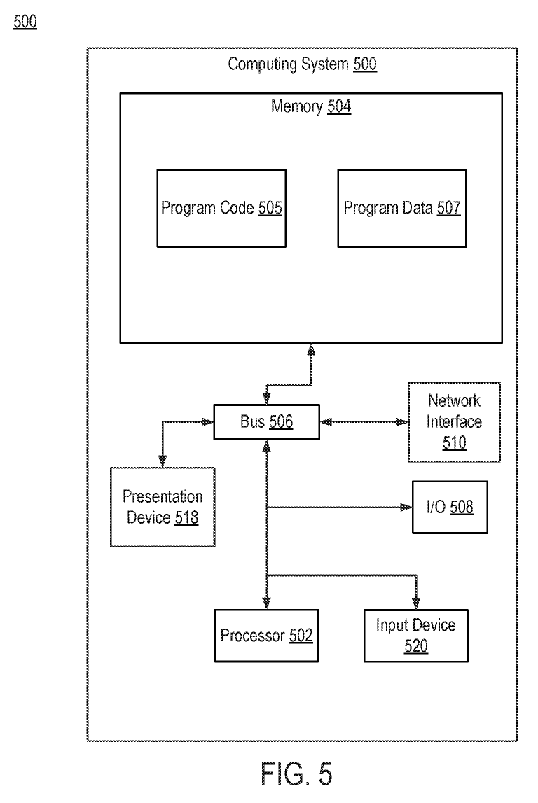

Any suitable computing system or group of computing systems can be used for performing the operations described herein. For example, FIG. 5 depicts an example computing system 500 used to perform user segmentation or topic modeling, according to certain embodiments of the present disclosure. The implementation of computing system 500 could be used for one or more of a segmentation application 110 or segmentation model 120.

The depicted example of a computing system 500 includes a processor 502 communicatively coupled to one or more memory devices 504. The processor 502 executes computer-executable program code stored in a memory device 504, accesses information stored in the memory device 504, or both. Examples of the processor 502 include a microprocessor, an application-specific integrated circuit (“ASIC”), a field-programmable gate array (“FPGA”), or any other suitable processing device. The processor 502 can include any number of processing devices, including a single processing device.

A memory device 504 includes any suitable non-transitory computer-readable medium for storing program code 505, program data 507, or both. Program code 505 and program data 507 can be from segmentation application 110, segmentation model 120, an electronic content delivery system 190, or any other application described herein. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 500 may also include a number of external or internal devices, an input device 520, a presentation device 518, or other input or output devices. For example, the segmentation computing environment 100 is shown with one or more input/output (“I/O”) interfaces 508. An I/O interface 508 can receive input from input devices or provide output to output devices. One or more busses 506 are also included in the computing system 500. The bus 506 communicatively couples one or more components of a respective one of the computing system 500.

The computing system 500 executes program code 505 that configures the processor 502 to perform one or more of the operations described herein. Examples of the program code 505 include, in various embodiments, modeling algorithms executed by the segmentation application 110, the segmentation model 120, or other suitable applications that perform one or more operations described herein. The program code may be resident in the memory device 504 or any suitable computer-readable medium and may be executed by the processor 502 or any other suitable processor.

In some embodiments, one or more memory devices 504 stores program data 507 that includes one or more datasets and models described herein. Examples of these datasets include interaction data, experience metrics, training interaction data or historical interaction data, transition importance data, etc. In some embodiments, one or more of data sets, models, and functions are stored in the same memory device (e.g., one of the memory devices 504). In additional or alternative embodiments, one or more of the programs, data sets, models, and functions described herein are stored in different memory devices 504 accessible via a data network.

In some embodiments, the computing system 500 also includes a network interface device 510. The network interface device 510 includes any device or group of devices suitable for establishing a wired or wireless data connection to one or more data networks. Non-limiting examples of the network interface device 510 include an Ethernet network adapter, a modem, and/or the like. The computing system 500 is able to communicate with one or more other computing devices (e.g., a computing device executing an electronic content delivery system 190) via a data network using the network interface device 510.

In some embodiments, the computing system 500 also includes the input device 520 and the presentation device 518 depicted in FIG. 5. An input device 520 can include any device or group of devices suitable for receiving visual, auditory, or other suitable input that controls or affects the operations of the processor 502. Non-limiting examples of the input device 520 include a touchscreen, a mouse, a keyboard, a microphone, a separate mobile computing device, etc. A presentation device 518 can include any device or group of devices suitable for providing visual, auditory, or other suitable sensory output. Non-limiting examples of the presentation device 518 include a touchscreen, a monitor, a speaker, a separate mobile computing device, etc.

Although FIG. 5 depicts the input device 520 and the presentation device 518 as being local to the computing device that executes the segmentation computing system 101, other implementations are possible. For instance, in some embodiments, one or more of the input device 520 and the presentation device 518 can include a remote client-computing device that communicates with the computing system 500 via the network interface device 510 using one or more data networks described herein.

General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes poses of example rather than limitation, and does not preclude the inclusion of such modifications, variations, and/or additions to the present subject matter as would be readily apparent to one of ordinary skill in the art.

1. A computer-implemented method of customizing an online experience, the method comprising:
accessing past user interaction vectors representing interaction data from an electronic content delivery system, the interaction data generated by prior interactions between one or more user devices and an interactive computing environment provided by the electronic content delivery system;
receiving, from a user device, a present user interaction vector representing an activity by a particular user device; and
causing the electronic content delivery system to modify the interactive computing environment based on a user segment computed from the interaction data, wherein causing the electronic content delivery system to modify the interactive computing environment comprises:
accessing a segmentation model having parameters,
updating the parameters by (i) performing tensor decomposition on a tensor built from the past user interaction vectors and (ii) calculating updated values of the parameters from the tensor decomposition,
performing a segmentation of user devices by applying the segmentation model with the updated parameters to the present user interaction vector, wherein the segmentation assigns the user device to the user segment, is derived from a set of past interaction vectors, and is trained to minimize a cumulative error with subsequent iterations,
removing a redundant user interaction vector from the past interaction vectors, wherein the redundant user interaction vector is determined at random,
updating the set of past user interaction vectors by adding the present user interaction vector to the set of past user interaction vectors; and
transmitting, to the electronic content delivery system, data describing the segmentation, wherein the data describing the segmentation is usable for customizing the interactive computing environment.

2. The method of claim 1, further comprising:
identifying a latent variable in the present user interaction vector, wherein the latent variable represents an unobservable factor, and wherein performing the segmentation of user devices is determined based on the latent variable.

3. The method of claim 1, further comprising:
receiving an additional present user interaction vector from an additional user device,
calculating an additional set of parameters by (i) performing tensor decomposition on a tensor built from the updated set of past user interaction vectors and (ii) calculating updated values of the parameters from the tensor decomposition, and
performing a segmentation of user devices by applying the segmentation model with the additional set of parameters to the additional present user interaction vector, wherein the segmentation assigns the additional user device to an additional user segment providing the additional set of parameters to the segmentation model.

4. The method of claim 1, further comprising:
receiving an additional present user interaction vector from the user device,
calculating an additional set of parameters by (i) performing tensor decomposition on a tensor built from the updated set of past user interaction vectors and (ii) calculating updated values of the parameters from the tensor decomposition, and
performing a segmentation of user devices by applying the segmentation model with the additional set of parameters to the additional present user interaction vector, wherein the segmentation assigns the user device to an additional user segment providing the additional set of parameters to the segmentation model, wherein the additional user segment is different from the user segment.

5. The method of claim 1, further comprising:
maintaining a number of past user interaction vectors within the set of past user interaction vectors below a threshold number of interaction vectors.

6. The method of claim 1, wherein the segmentation describing the data includes an assignment of the user device to the user segment.

7. The method of claim 1, wherein updating the parameters further comprises:
determining, from the user interaction vector, an outer product of the vectors;
determining, from the outer product, an eigenvector decomposition;
determining, from the eigenvector decomposition, a matrix whitening; and
the tensor is determined from the matrix whitening.

8. A computing system comprising:
an electronic content delivery system having a processing device configured for:
hosting an interactive computing environment,
generating interaction data based on interactions with one or more user devices via the interactive computing environment,
receiving segmentation data generated from the interaction data, and
modifying the interactive computing environment based on the segmentation data assigning a particular user device to a user segment; and
a segmentation computing system communicatively coupled to the electronic content delivery system via a data network, the segmentation computing system configured for:
receiving a present user interaction vector representing an activity by the particular user device at a point in time;
accessing (i) a segmentation model having parameters and (ii) past user interaction vectors representing the interaction data;
updating the parameters by (i) performing tensor decomposition on a tensor built from the past user interaction vectors and (ii) calculating a set of parameters from the tensor decomposition;
removing a redundant user interaction vector from the past interaction vectors, wherein the redundant user interaction vector is determined at random,
updating the set of past user interaction vectors by adding the present user interaction vector to the set of past user interaction vectors;
generating the segmentation data by applying the segmentation model with the updated parameters to the present user interaction vector, wherein the segmentation data includes an assignment of the user device to the user segment; and
transmitting, to the electronic content delivery system, the segmentation data.

9. The system of claim 8, wherein the segmentation computing system is further configured for:
identifying a latent variable in the present user interaction vector, wherein the latent variable represents an unobservable factor, and wherein performing the segmentation of user devices is determined based on the latent variable.

10. The system of claim 8, wherein the segmentation computing system is further configured for:
receiving an additional present user interaction vector from an additional user device,
calculating an additional set of parameters by (i) performing tensor decomposition on a tensor built from the updated set of past user interaction vectors and (ii) calculating updated values of the parameters from the tensor decomposition, and
performing a segmentation of user devices by applying the segmentation model with the additional set of parameters to the additional present user interaction vector, wherein the segmentation assigns the additional user device to an additional user segment providing the additional set of parameters to the segmentation model.

11. The system of claim 8, wherein the segmentation computing system is further configured for:
receiving an additional present user interaction vector from the user device,
calculating an additional set of parameters by (i) performing tensor decomposition on a tensor built from the updated set of past user interaction vectors and (ii) calculating updated values of the parameters from the tensor decomposition, and
performing a segmentation of user devices by applying the segmentation model with the additional set of parameters to the additional present user interaction vector, wherein the segmentation assigns the user device to an additional user segment providing the additional set of parameters to the segmentation model, wherein the additional user segment is different from the user segment.

12. The system of claim 8, wherein the segmentation computing system is further configured for:
maintaining a number of past user interaction vectors within the set of past user interaction vectors below a threshold number of interaction vectors.

13. The system of claim 8, wherein the segmentation describing the data includes an assignment of the user device to the user segment.

14. The system of claim 8, wherein updating the parameters further comprises:
determining, from the user interaction vector, an outer product of the vectors;
determining, from the outer product, an eigenvector decomposition;
determining, from the eigenvector decomposition, a matrix whitening; and
the tensor is determined from the matrix whitening.

15. A non-transitory computer-readable medium having program code that is stored thereon, the program code executable by one or more processing devices for performing operations comprising:
accessing past user interaction vectors representing interaction data from an electronic content delivery system, the interaction data generated by prior interactions between one or more user devices and an interactive computing environment provided by the electronic content delivery system;
receiving, from a user device, a present user interaction vector representing an activity by a particular user device; and
causing the electronic content delivery system to modify the interactive computing environment based on a user segment computed from the interaction data, wherein causing the electronic content delivery system to modify the interactive computing environment comprises:
accessing a segmentation model having parameters,
updating the parameters by (i) performing tensor decomposition on a tensor built from the past user interaction vectors and (ii) calculating updated values of the parameters from the tensor decomposition,
performing a segmentation of user devices by applying the segmentation model with the updated parameters to the present user interaction vector, wherein the segmentation assigns the user device to the user segment, is derived from a set of past interaction vectors, and is trained to minimize a cumulative error with subsequent iterations,
removing a redundant user interaction vector from the past interaction vectors, wherein the redundant user interaction vector is determined at random;
updating the set of past user interaction vectors by adding the present user interaction vector to the set of past user interaction vectors; and
transmitting, to the electronic content delivery system, data describing the segmentation, wherein the data describing the segmentation is usable for customizing the interactive computing environment.

16. The non-transitory computer readable medium of claim 15, wherein causing the electronic content delivery system to modify the interactive computing environment further comprises identifying a latent variable in the present user interaction vector, wherein the latent variable represents an unobservable factor, and wherein performing the segmentation of user devices is determined based on the latent variable.

17. The non-transitory computer readable medium of claim 15, wherein causing the electronic content delivery system to modify the interactive computing environment further comprises:
receiving an additional present user interaction vector from an additional user device,
calculating an additional set of parameters by (i) performing tensor decomposition on a tensor built from the updated set of past user interaction vectors and (ii) calculating updated values of the parameters from the tensor decomposition, and
performing a segmentation of user devices by applying the segmentation model with the additional set of parameters to the additional present user interaction vector, wherein the segmentation assigns the additional user device to an additional user segment providing the additional set of parameters to the segmentation model.

18. The non-transitory computer readable medium of claim 15, wherein causing the electronic content delivery system to modify the interactive computing environment further comprises:
receiving an additional present user interaction vector from the user device,
calculating an additional set of parameters by (i) performing tensor decomposition on a tensor built from the updated set of past user interaction vectors and (ii) calculating updated values of the parameters from the tensor decomposition, and
performing a segmentation of user devices by applying the segmentation model with the additional set of parameters to the additional present user interaction vector, wherein the segmentation assigns the user device to an additional user segment providing the additional set of parameters to the segmentation model, wherein the additional user segment is different from the user segment.

19. The non-transitory computer readable medium of claim 15, wherein causing the electronic content delivery system to modify the interactive computing environment further comprises:
maintaining a number of past user interaction vectors within the set of past user interaction vectors below a threshold number of interaction vectors.

20. The non-transitory computer readable medium of claim 15, wherein causing the electronic content delivery system to modify the interactive computing environment further comprises, wherein the segmentation describing the data includes an assignment of the user device to the user segment.
